(19) United States
(12) Patent Application Publication
(10) Pub. No.: US 2014/0068854 A1
(43) Pub. Date: Mar. 13, 2014

(54) Nursing Care Support Device

(71) Applicant: Noboru Konishi, Kyoto City (JP)

(72) Inventor: Noboru Konishi, Kyoto City (JP)

(21) Appl. No.: 13/606,093

(22) Filed: Sep. 7, 2012

(51) Int. Cl. A61G 7/10

(52) U.S. Cl. CPC A61G 7/1046
USPC 5/87.1

(57) ABSTRACT

The nursing care support device according to the present invention can help to lift and transfer a person who requires nursing care and cannot rise up and walk on their own. The nursing care support device of the present invention can ease the burden of a caregiver and a person who requires nursing care at the time of the use. The nursing care support device of the present invention can also be used as a walking auxiliary device such as a walker for a person who recovers enough to walk using a walk assistance device.

### BACKGROUND OF THE INVENTION

1. Field of the Invention

This invention relates generally to a nursing care support device to help people who requires nursing care and, more particularly to a carrying device that is used to help people who requires nursing care to move from one location to another, also to a walking aid which can assist a person who recovers enough to walk with a walking aid.

2. Description of Related Art

To move those who require nursing care from bed to toilet imposes heavy burden on care personnel. In addition, the sequence of motion to get one's arm around the person who requires nursing care or use the wheel chair from bed to toilet is a heavy burden for the caregiver's lower back.

Therefore, it is necessary to have a device that can help caregiver to lift a person who cannot rise from the bed on their own and transfer a person who cannot stand or walk on their own.

### SUMMARY OF THE INVENTION

In an exemplary embodiment of the present invention, there is disclosed a nursing care support device which can be used to help people who require nursing care to move from one location (such as bed) to another. This nursing care support device has a seat and arms. These are located on the frame of the carriage which has wheels. The seat and arm parts are also able to move up and down. The motor provides the power source for this movement. The usage of this device will be explained as follows.

First, move this device close to the bed that the person who needs nursing care is sitting on. Secondly, adjust the height of the arm parts and the seat to match the position of the person's arm pits and bottom. Then, move device towards the person and place arm parts under the person's arm pits and seat under the person's bottom. Lift the person up from the bed by moving arm parts and seat with motor. When the person is placed on the seat of the aid device, it is possible to take this patient to the toilet by just moving the device.

In addition, the device of the present invention may be used as a walking aid device for a person who recovers enough to walk by him or herself. If the person recovers enough to function alone then rehabilitation is implemented. A walking aid such as a walker is disclosed. This device is convenient for walking training implementation in which a traditional walker is needed.

This device is not only useful for people who are not institutionalized, but will also help to make patients more vibrant because it helps with rehabilitation. At nursing homes, there are many levels of treatments used to help patients. This machine is multi-functional, and useful at these institutions. It will help to rid both patients and nurses of additional burden. This invention can be used as a device to transport patients who are not ambulatory and those who need rehabilitation.

This device comprises supporters for the upper body and which is connected to two parallel pipes of the post. The post's pipes are connected to the truck which includes two elongated frame members and wheels.

The supporter for the upper body comprises two arms which stretch horizontally to the floor F and two tilted vertical rods connecting the two arms to the post.

The two rods of the upper body support are respectively connected to the two pipes of the post so that they can be stretched upward, in a diagonal position. The length of the two rods from the upper edge of the two pipes of the post can also be adjusted.

The device comprises a seat part which is connected to a mobilized robot and is moveable along the vertical direction (up and down). The seat has two tapered shaped plates for easy insertion between the person who needs nursing care and the furniture the person sits or lies on. The caregiver does not need to lift up the person to insert the seat beneath the person's bottom. The device further comprises a hoist unit to help lift the seat up and down by pressing (stepping) on the pedals. The caregiver can move the person from bed to the device without performing any physical lifting.

According to this invention it provides not only factors for patients to move, but acts as a support device for patients to use for walking. This device replaces the traditional walker as one of its functions.

When using this device, the supporter can move the patient from bed to device, as the helper is standing and does not have to perform any physical lifting.

The supporter does not have to move, or lift the patient. In addition, the patient need not rise or stand on their feet.

This device can be used as the supporter's device for moving patients. In fact, this device decreases the burden and physical pressure on both patient and caregiver.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of the first embodiment of the device in accordance with the present invention.

FIG. 2 is a front view of the device of FIG. 1.

FIG. 3 is a slant view of the device of FIG. 1.

FIG. 4 is a side view of the device of FIG. 1 in a position that the seating part is raised according to the present invention.

FIG. 5 is a side view of the device of FIG. 1 in a position that the plug component is lifted up.

FIG. 6 is a top view of an example of the seating part in accordance with the present invention.

FIG. 7 is a side view of the plate which constitutes plug component for insertion in accordance with the present invention.

FIG. 8A is a side view showing an example of the use of the device for transporting a patient when the device is approaching a patient.

FIG. 8B is a side view of the example of this device in use for transporting a patient when the arm parts has placed under a patient's arm and the plug component has been inserted under a patient's buttocks.

FIG. 8C is a side view of the example of the device in use for transporting a patient when the seating part is raised and moved away from the bed.

FIG. 8D is a side view of the example of the device in use for transporting a patient showing the patient is being transported.

FIG. 9 is a side view of the example of the device in use as a walking supporting device.

FIG. 10 is a side view of another example of this device in accordance with the present invention.

FIG. 11A is a side view of the device of FIG. 10 in use for transporting a patient which is set in a position to let the patient sleep.

FIG. 11B is a side view of the device of FIG. 10 in use for transporting a patient showing the device is set in a position to let the patient ride.

FIG. 11C is a side view of the device in use for transporting a patient showing the situation when the patient has to lie chest down and device is placed under patient's arms.

FIG. 11D is a side view of the device in use for transporting a patient showing the situation when the patient is transported.

### DESCRIPTION OF THE PREFERRED EMBODIMENT

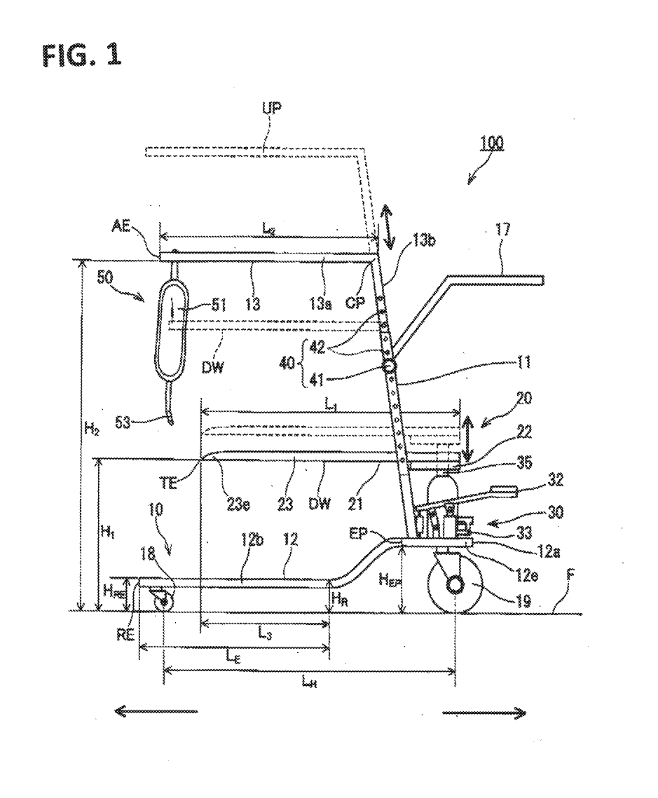

Referring to FIGS. 1-9, there is disclosed a first embodiment of the present invention.

FIGS. 1 to 5 show the first embodiment of the nursing care support device 100 according to the present invention. In the following description, the direction towards the left side is the first direction as indicated in FIG. 1. The direction towards the right side is the second direction as indicated in FIG. 1. The first and second directions run parallel to the floor F. The third direction is vertical direction which is perpendicular to the floor F. In FIG. 1, the nursing care support device 100 is presented in a side view with its front end facing along the second direction and its rear end facing along the first direction.

Nursing care support device 100 in FIGS. 1 to 3 comprises a truck part 10. The truck part 10 has a frame part 12 and wheels 18, 19 which are fixed to the frame part 12. Truck part 10 can run on the floor F with various members and device placed on the truck part 10.

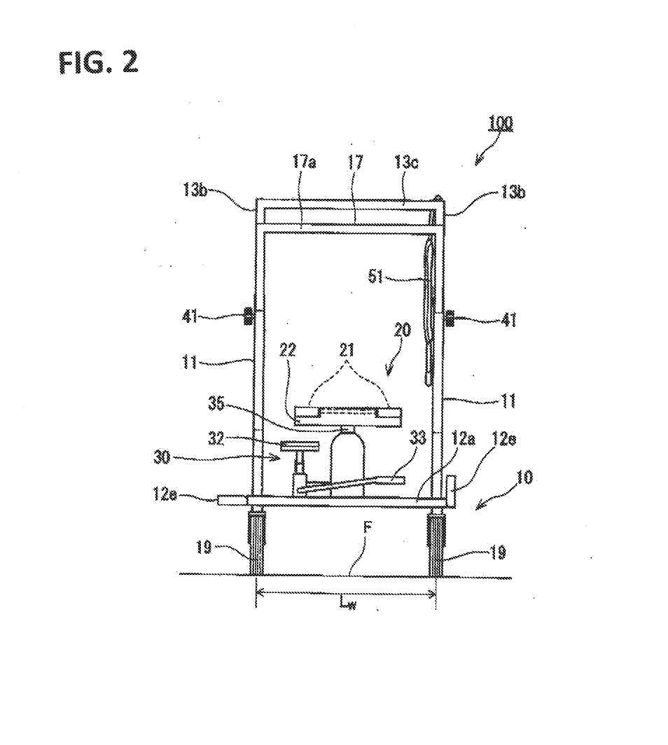

Frame part 12 comprises a pedestal part 12a and two parallel elongated members (also known as “rod legs”) 12b extending from the pedestal part 12a along the first direction. The two parallel elongated members are separate by a distance Lw which is about the length of the pedestal part 12a (FIG. 2). The wheels 18 are attached to the bottom surface near the rear end of the two rod legs 12b, respectively. The wheels 19 are connected to the bottom surface in the vicinity of both ends of the pedestal part 12a.

Footrests 12e are hingedly connected to the end face on both sides of the pedestal part 12a so that the footrests can be folded upwards.

Nursing care support device 100 further comprises a post part 11 which including a pair of two parallel pipes 11 extending upwards from the top surface of the pedestal part 12a along a slightly diagonal direction towards the rear end of the device. Post 11 is a part that holds the projection part 13b; which may be placed in a diagonal direction.

The device 100 further comprises an upper body support part 13 which is connected to the post 11. The upper body support 13 comprises an arm part 13a and projection part 13b which connects the arm part 13a and post 11. The projection part 13b is composed of two parallel rods extending upwards in the same direction. These rods are fitted into the two pipes which make up the post 11 and the length of the rods beyond the top edge of the post 11 is used for adjusting the height of the arm part 13a. Arm part 13a consists of two rods which are placed parallel to each other. These rods extend along the first direction from the upper ends of the projection part 13b. The arm part 13a is extended horizontally and parallel to the floor F. Arm part 13a supports the person who needs help.

The upper body support section 13 further includes a connection portion which is a rod 13c across between the two rods of projection part 13b and which is also connected to the two rods of the arm part 13a.

The projection part 13b is fitted inside the post 11 and fixed to the post 11 through the Guizhou connection mechanism 40 that comprises a screw hole 42 and a screw member 41. Both the projecting portion 13b and post 11 have a plurality of screw holes 42. The post 11 further has a screw member 41. Thus, by selecting the screw holes 42 and screwing the screw member 41 into the selected holes on both projection portion 13b and post 11, it is possible to adjust the length of the projecting portion 13b exposed outside the post 11, and therefore adjusting the height of the arm part 12a. The longer the length of the projection part 13b beyond the post 11, the higher positioned the arm part 13a and 13c are.

The device 100 further comprises an operation unit 17 which is provided to the caregiver for moving the device 100. This operation unit 17 consists of a rod which is in U shape with its two ends connecting to the two pipes of the post 11 near the top edge of the two pipes. arranged to pass over the two pipes which make up the post 11. The operation unit 17 is built so as to be positioned on the side direction from the post 11 which is U shaped when viewed along the vertical direction. The operation section 17 has a hand gripping portion 17a which is horizontal and parallel to the connection part 13c. The caregiver operates the device 100 by holding the hand grip 17a.

The device 100 further comprises a rear support component 50 to secure the back side of the person sitting on the device 100. The rear support component 50 includes a supporter cloth 51 which is removably attached to the rear end of one rod of the arm part 13a, a pin 53 which is attached to the supporter cloth 51, and a hole 54 which is located on the end of the other rod of the arm part 13a. By inserting the pin 53 into the hole 54, the support cloth 51 is disposed across the two ends of the rods of the arm part 13a and thus secure the backside of the person sitting on the device 100.

The device 100 further comprises a rise-and-fall unit (a hoist unit) 30 which is located on the pedestal part 12a. In the illustrated figure, an oil hydraulics jug is used in the hoisting unit 30. The hoist unit 30 further comprises a mobilized robot 35, and pressure pedals 32, 33. The device 100 further comprises a seating part 20 which is connected to the top surface of the mobilized robot 35.

This oil hydraulics jug is a better hoisting machine than a motor because it does not use external power or batteries (at all). By stepping on the pressure pedals 32 and 33, the mobilized robot 35, will go upwards or downwards. Using these pedals 32 and 33, one can adjust the height of the seating part 20 by adjusting the position of the top surface of the mobilized robot 35.

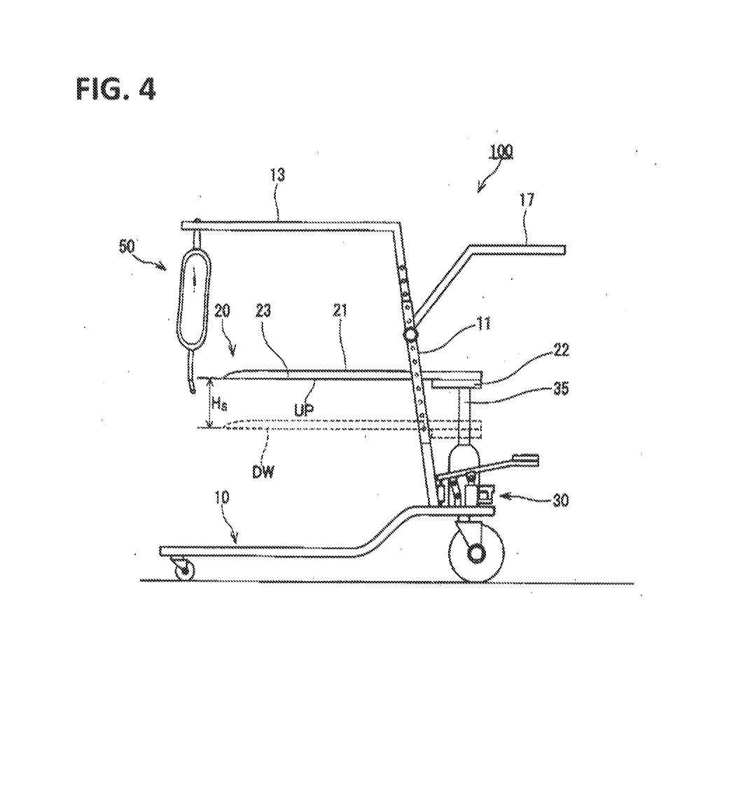

In FIG. 4, it shows the lowest position of the seating part 20 as DW (as indicated in a dashed line in FIG. 4) and the highest position on the seating part 20 as UP (as indicated in a solid line in FIG. 4). The distance (Hs) between these two positions is preferred as 10 cm or more, and it is best preferred as 15 cm or more. For example the difference Hs is about 15 cm-30 cm.

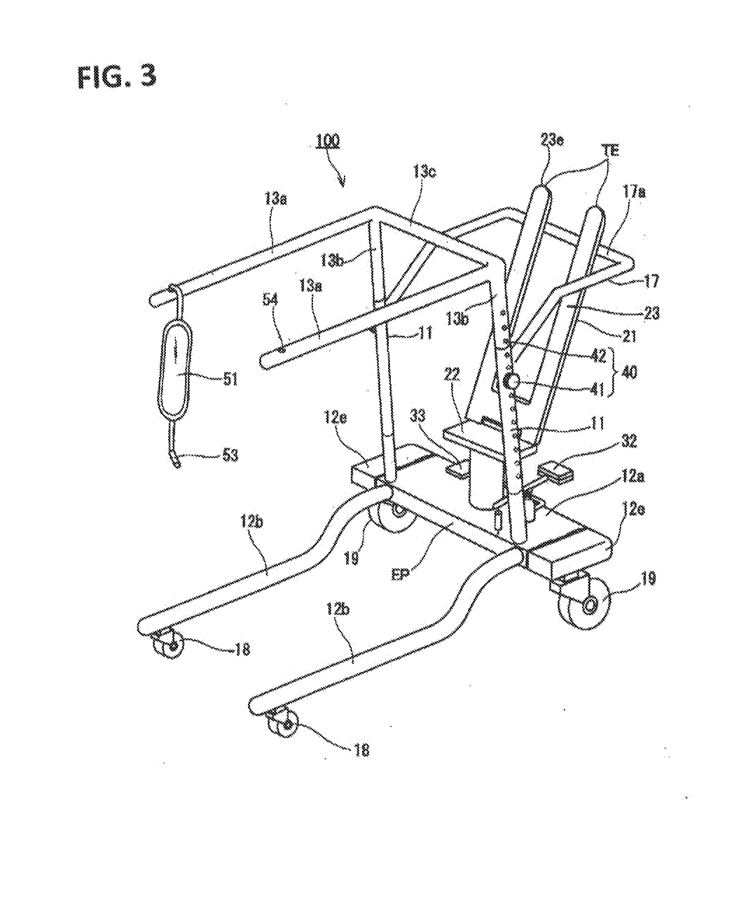

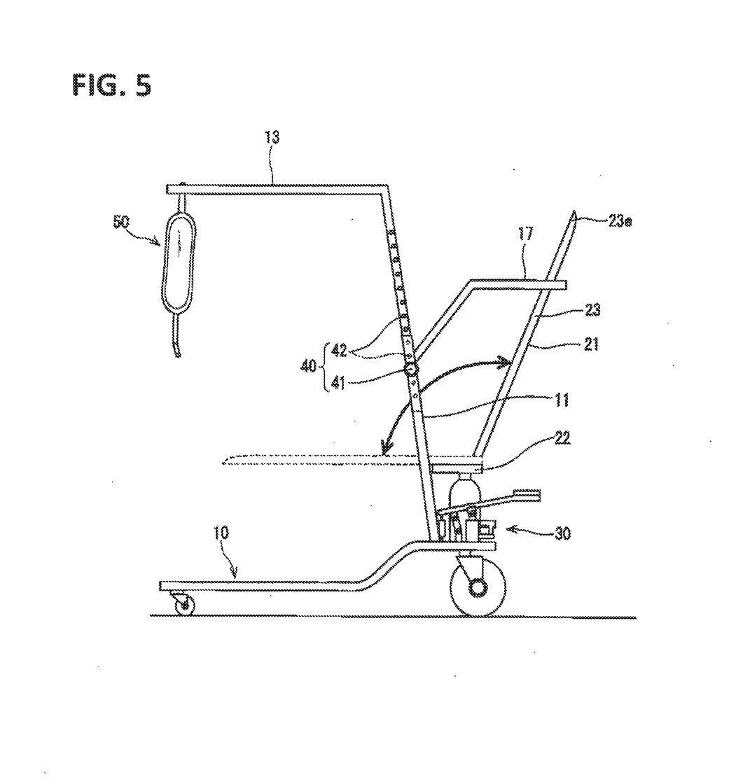

Seating part 20 comprises a plugging component 21 which is constructed with two plates 23, and a supporting component 22 which is equipped to help with the plugging of component 21. The supporting component 22 is connected to the top surface of the mobilized robot 35. The front end of the plugging component 21 is hingedly connected to front edge of the supporting component 22 so that the plugging component 21 can pivot about the edge of the supporting material 22. FIGS. 1 and 4 demonstrate the plugging component 21 is disposed in a horizontal position (the first position), and FIG. 3 demonstrates the plugging component 21 is disposed in a tilted vertical position (the second position). FIG. 5 illustrates how the supporting component 22 helps the plugging component 21 to move reversibly from the 1st position (horizontal position) where the plugging component 21 is shown in dashed line to the 2nd position (tilted vertical position) where the plugging component 21 is shown in solid line. When the device 100 is used as a device to help lift and move a person, the plugging component 21 should be disposed horizontally (first position). When the device 100 is used as a walking aid, the rear end of the plugging component 21 should be lifted up so that the plugging component is disposed in a tilted vertical position (second position) then the plugging component 21 will be out of the way of the person who uses the device 100 as a walking aid.

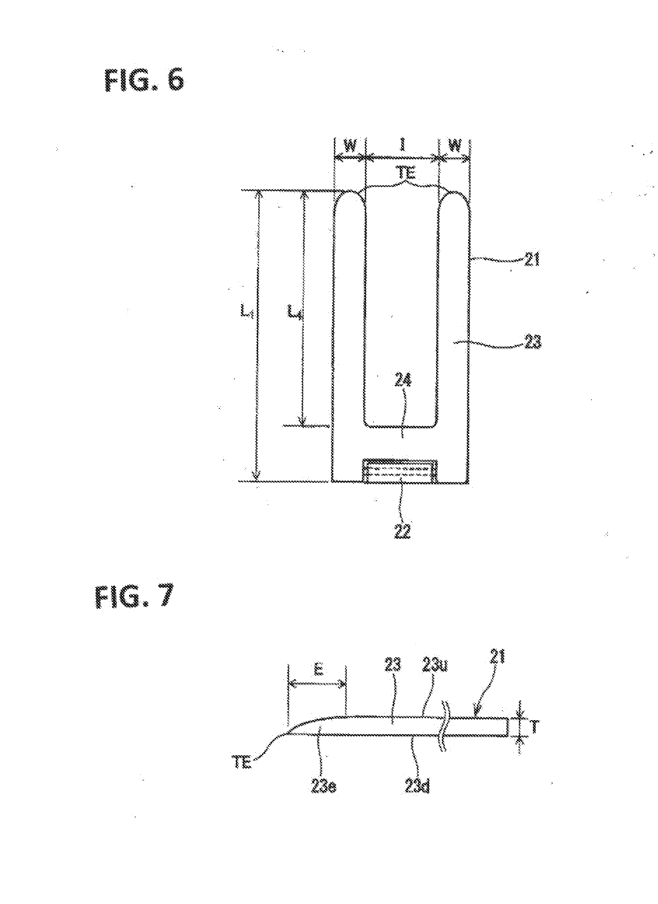

As it is illustrated in the FIGS. 6 and 7, the plugging component 21 is equipped with the two plates 23, which are placed and kept in the predetermined distances (l), and a connecting plate 24 which is integrally connecting the two plates 23. In the illustrated form, the connecting plate 24 is placed near the rear end of the two plates 23. Each plate 23 has two side edges (23e), an upper surface (23u) which may be a curved surface, a lower surface (23d), and a rear end with a tip (TE) and a front end. As mentioned earlier, the front end is hingedly connected to the front edge of the supporting component 22. Each plate has a thickness T which is the distance between the upper and lower surface 23u, 23d and a width W which is the distance between the two side edges 23e, a full length L1 and a length L4 which is the distance starting from the rear end of the supporting component 22.

The plugging component 21 is used to slip in between the person's bottom and the furniture (e.g. a bed) where the person sits or lies on and thus it is better that the plate 23 has a tapered shape as shown in FIGS. 6 and 7. The reason for this is to make the plugging easier between the person requiring long-term care and the furniture (a bed, etc.) It means that the side edge 23e move closer to each other when approaching towards the rear end tip TE, and the upper surface 23u moves toward the lower surface 23 d when approaches toward the rear end tip TE. In another words, both the width W and the thickness T gradually decrease within the section (E) which is near the rear end towards the rear end tip TE.

The width W of the plate 23 excluding the section E is 5 cm to 15 cm, and preferably 6 cm to 13 cm, but it is best to have a width of 7 cm to 12 cm. If the width W is too narrow, there wouldn't be enough strength to support the human body, and if the width W is too wide, it would be difficult to plug in between the person's bottom and the bed, for instance.

The thickness T of the plate 23 depends on the materials that are needed to make the plate. The thickness T of the plate 23 excluding the section E is about 1 cm to 4 cm, and preferably from 1 cm to 3 cm.

The spaces I between the two plates 23 as shown in FIG. 6 is about 5 cm to 25 cm, preferably 9 to 23 cm, and preferably 12 to 18 cm.

The full length L1 of plugging component 21 is 45 cm to 75 cm, and 50 cm to 65 cm are said to be the best. The length L4 of the two plates 23 is 40 cm to 65 cm, as well as 45 cm to 60 cm are believed as the best.

The plates 23 may be covered by a coating on their surface to reduce the resistance fraction. For example, urethane coating may be used to cover the plate for reducing the friction resistance.

It is appropriate to set the thickness T, and maybe width W for some cases, to 1 cm to 10 cm from the edge of plate 23, and better yet 2 cm to 8 cm at length E (refer to FIG. 7).

The plugging material used in conventional machines used to help move a person who requires nursing care normally are annularly in design with strength as the priority. However, in this form, it is impossible to slip the plugging component between the bed and person without lifting them up. This type of conventional device causes burden to both the person who needs nursing care and caregiver. In order to ease the movement and reduce the burden, it is necessary to place the plugging component in the seating place without lifting the person up. The device 100 of the present invention using two tapered shaped plates 23 as the plugging component 21 instead of the annular shaped plugging material help to smoothly place the plugging component between the person and the sitting furniture (e.g. a bed) without lifting the person up.

Now, refer back to FIG. 1 for details about the shape of the truck frame part 12. The height H_{EP} from the floor surface F to the bottom surface of the pedestal part 12a should be 15 cm or more, or preferred as 17 cm or more, and best preferred as 18 cm or more, especially best with setting the height as 20 cm or more. When the device 100 is used as a walking aid, the users can use the arm 13a to support the upper part of their body and at the same time, walk along the 2nd direction. This means that if the height H_{EP} is set too low, the pedestrians will have difficulty to move forward when the pedestal part 12a is on their way. On the other hand, from the prospective of securing the spaces of hoisting unit 30, the height H_{EP} should be 30 cm or less, and also 27 cm or less, or in some cases it may be best to set the height as 25 cm or less.

When considering using the walking supplementary device, it is best that the end surface EP of the pedestal part be set behind the side of the 2nd direction when viewed from the direction of the arm 13a. Specifically it is best to have the end surface EP placed in the side of the 2nd direction, more than placing it on the part of the two 13a arms, when height H2 of the two arms 13a are maintained as 120 cm from the surface F and the connecting part CP of the connecting place 13b in the two arms 13a. From this form of placement, the arm 13a will be a good device to support the users when it is on the side of the 1st direction than the bottom surface EP. It is also best to have all places on the side of the 1st direction. From these relationships of the placement, the arm 13a can support the upper part of the body which makes the walking become much easier. In this case, the standard estimate height of the arm 13a should be “120 cm” when the machine is used as the pedestrian supplementary device.

When the machine is used as the pedestrian supplementary device, the upper supportive part 13 is normally pulled and raised to the place that is used as the movable device for the person requiring long-term care. From this reason, the arm 13a meets the movement of the strut 11 and all in all, it not only moves upwards, but it also moves towards the side of the 1st direction (FIG. 1, the left direction). In other words, the strut 11, as well as the projection part 13b, tilting towards the side of the 1st direction, contributes when the connecting place CP moves further away from the end surface EP to the side of the 1st direction. Considering this movement, it is best to have the tilting degree of strut 11 as big as possible. On the other hand, if the strut 11 tilts too much, the strength of strut 11 is decreased, creating and causing a problem. The degree the strut is tilted from the vertical direction should be 5 to 30 degrees, and best suited as 7 to 20 degrees.

It is possible to think of maintaining the space for the pedestrians, without tilting the strut 11, by having all of pedestal part 12a moves towards the 2nd direction and have the bottom surface EP behind the pedestal part 12a. However, if all of the pedestal part 12a moves towards the 2nd direction, there will be materials on the caregiver's feet, when controlling the device from the side of the 2nd direction which will cause the person hard to walk.

In the illustrated form, the two pipes are placed so that they will stretch (rise) upward from the upper surface near the edge of the side of the 1st direction, to moving across from the above. From this, in order to move the connecting place of strut 11 and seating part 12a from the center of the seating part towards the side of the 1st direction, means it is best to place the bottom surface EP to the side of the 2nd direction than placing it on the connecting place CP.

If using the device 100 to move the person requiring long-term care from the bed, the leg rod 12b will be plugged in between the bed and the surface F. Therefore, the leg rod 12b, should be constructed so that the upper edge will not be too high from the surface F. Specifically, the height H_{RE}, from the surface F to the upper surface of the frame leg 12b should be less than 12 cm, and less than 10 cm or in some cases it may be best to have the height less than 8 cm. Then it is possible to plug in the leg rod 12b, even within the spaces of the surface F and the narrow bed, from these small numbers (low numbers) added onto the height H_{RE}. On the other hand, from looking at maintaining the spaces of the wheel 18 and the thickness of leg rod 12b, the height HRE should best be more than 5 cm.

From the same perspective as the above the leg rod 12b in the area LE of one of the end of edge RE in the side of the 1st direction, the height H_{R} of each leg rods 12b, from the upper edge to the surface F, should be less than 12 cm, or furthermore, less than 10 cm and in some cases, it may be best to set the height as less than 8 cm. The area LE is a determined area by the spaces between the 1st perpendicular line that stretches vertically after passing the two leg rods 12b of the edge RE in the side of the 1st direction, and the 2nd perpendicular line that stretches vertically after passing the place that moved length L3 from the edge TE in the side of the 1st direction to the 2nd direction of the plugging component 21 in the 1st position. This is when observing the device 100 along the 3rd direction (FIG. 1 vertical direction from the paper; the horizontal direction that lies at the right angle from surface F to the 1st direction and the 2nd direction.) The length L3 is best determined when considering the length of plugging component 21 when plugging it between a person requiring a long term care and the bed. The length L3 is preferred as 40 cm, but best preferred as 45 cm.

In this case, from the above-mentioned range Le, toward the second direction, the two leg rods 12b rise up, and are connected to the pedestal part 12a. Thus, the leg rod 12b is designed so that the height of the leg rod from the floor F becomes higher where it connects with the pedestal part 12a. The design of the device makes for an easy walk assistance.

H1 is the height from the floor F to the bottom of the plate 23. The H1 is about 35-45 cm and may be varied depending on the height of the bed. H2 is the height from the floor F to the bottom of the arm part 13a. The H2 is about 65-75 cm when in the first position for use as a carrying device to lift the patient from the bed. The H2 is about may be adjusted to about 110-140 cm when the device is in the second position for use as a walking aid by adjusting the length of the projection part 13b beyond the top end of the post 11.

As for the interval LH (wheel base) of the first wheel 18 and the second wheel 19, about 50-90 cm is suitable. About 45-65 cm is suitable for the interval Lw between the pair of first wheels 18 or the pairs of second wheels 19. If the nursing care assistant device 100 is too wide it may be hard to pass through the hallway of ordinary homes, etc.

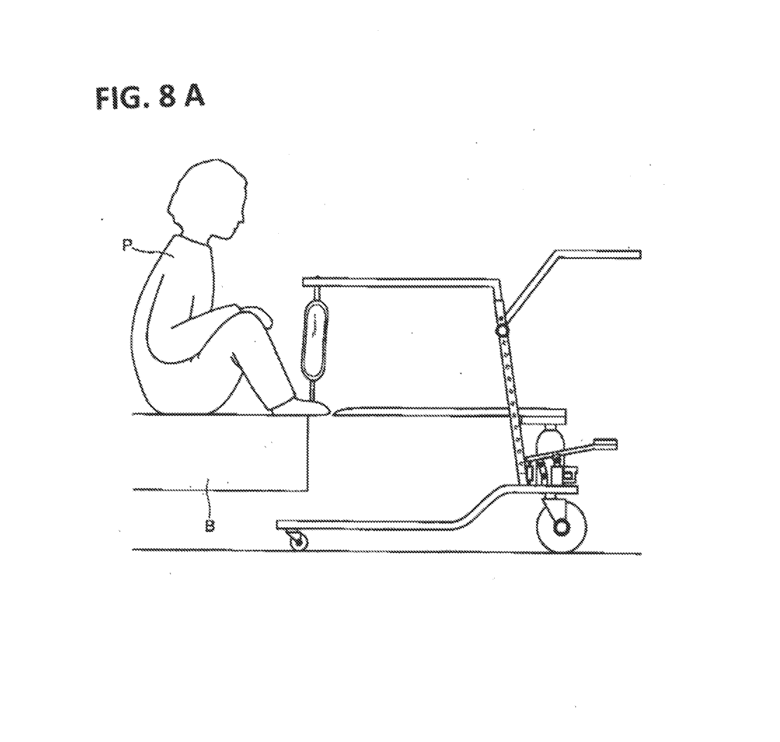

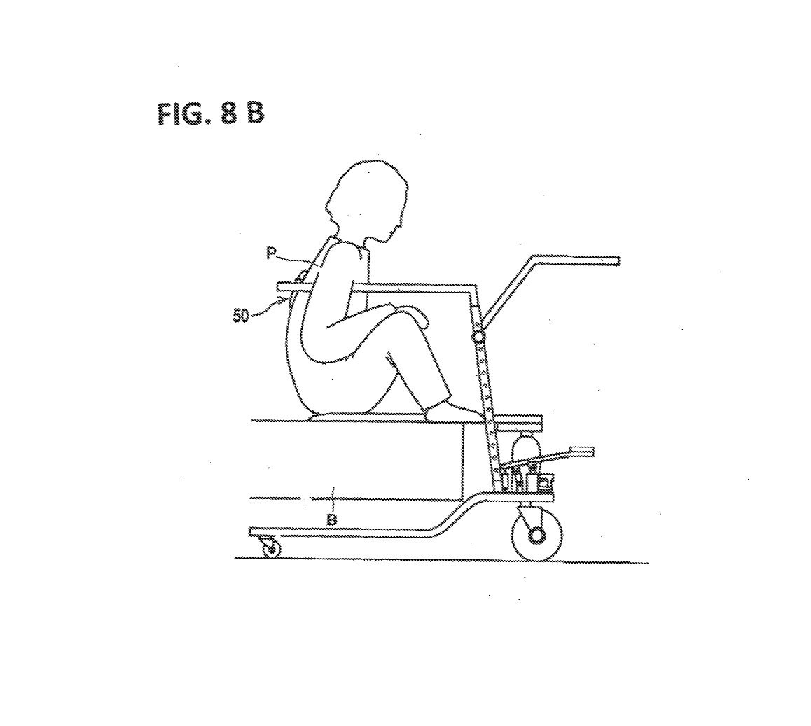

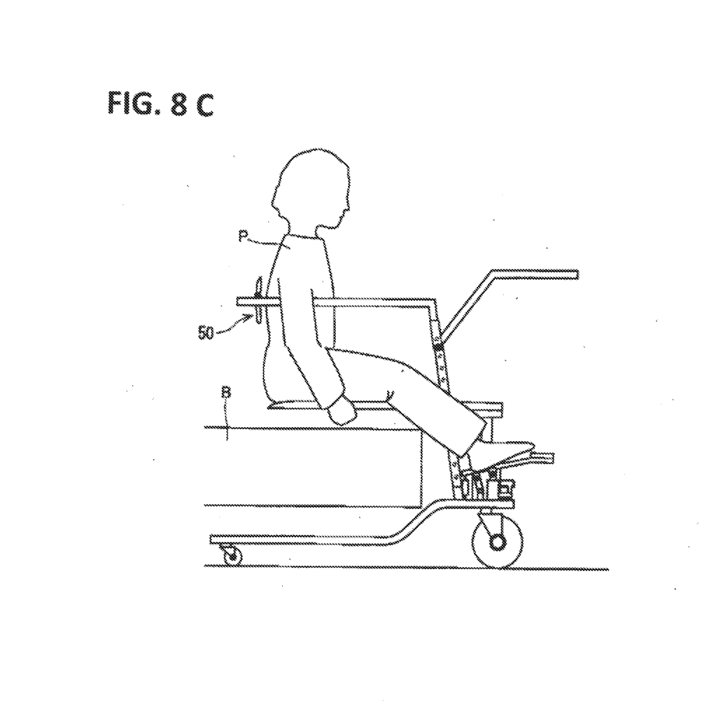

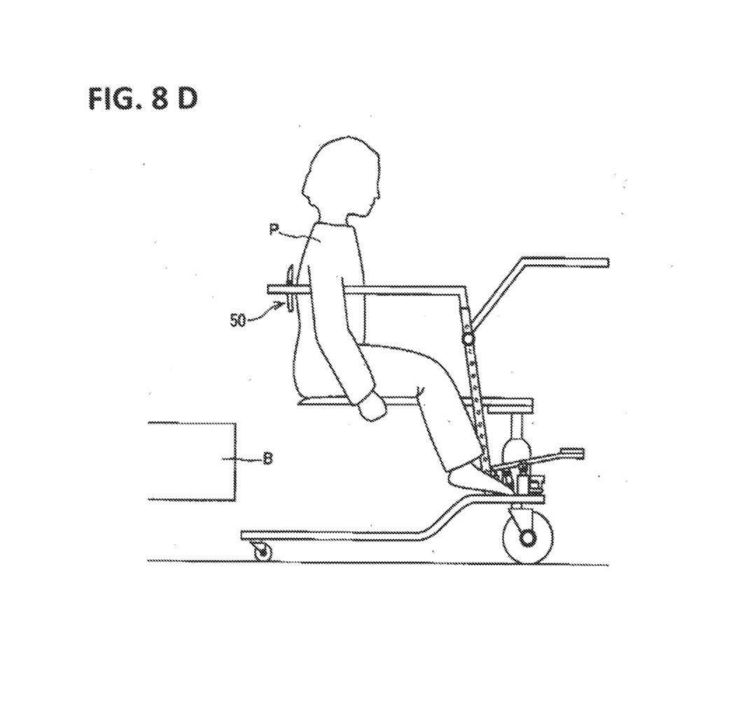

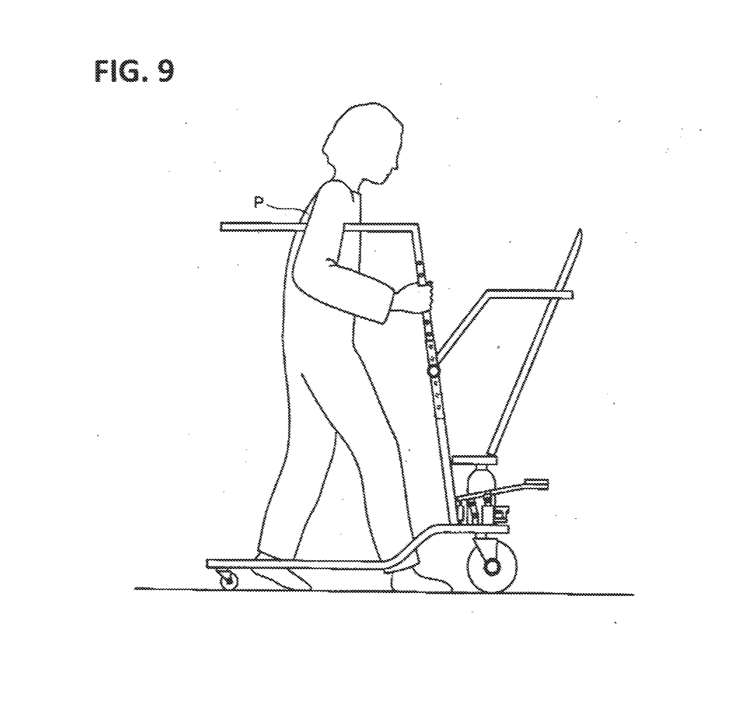

Hereinafter, FIGS. 8A-8D describe how a person use this device 100.

First, the device 100 is brought close to the bed with the tip portion 23e of the plates 23 in the plug component 21 in the first position facing towards the person P requiring care who is in the sitting position on the bed B (FIG. 8A). At this time, make the person P requiring care to bend her knees (FIG. 8A). Adjust the height of the plate 23 of the plug component 21 to align with the top surface of the bed and the arm part 13a to align with the height of the person's arm pit. Move the device 100 towards the person and insert the plate 23 of the plug component 21 in between the person's buttock and the bed's surface. Simultaneously, ask the person to put their arms over and around the arm part 13a (FIG. B). Raise the seat 20 (including plate 23 of the plug component 21) using the rise-and-fall device 30. Before moving away the device 100 from near the bed, ask the person to stretch her legs and put them on the footrest 12e which are connected to the side of the pedestal portion 13a to stabilize the posture (FIG. 8C). Slowly pull the device 100 apart from the bed B in this state, the person P requiring care can be moved from the bed (FIG. 8D). The cloth support 50 may be attached to the rear ends of the two arm parts to secure the person's back to prevent the person from falling back.

The device 100 may transfer person who requires nursing care from location to location (furniture to furniture) including a bed to a toilet and vise versa.

FIG. 9 shows the state of the nursing care support device 100 for use as a walking assist device. The upper body support portion 13 is pulled up and fixed in position. The plug component 21 is placed in the second position (where the plug component is pointing upwards with the rear end TE up instead of lying in a horizontal position). Between the floor F and the base portion 12a, sufficient space has been reserved for the feet to let the person walk conveniently.

Although FIG. 9 shows that the person putting her arms over the arm part 13a and holding the projection part 13b while walking t support her upper body, the use of the device 100 is not restricted to the use shown in FIG. 9. For example, the person can hold the connection part 13a and walk.

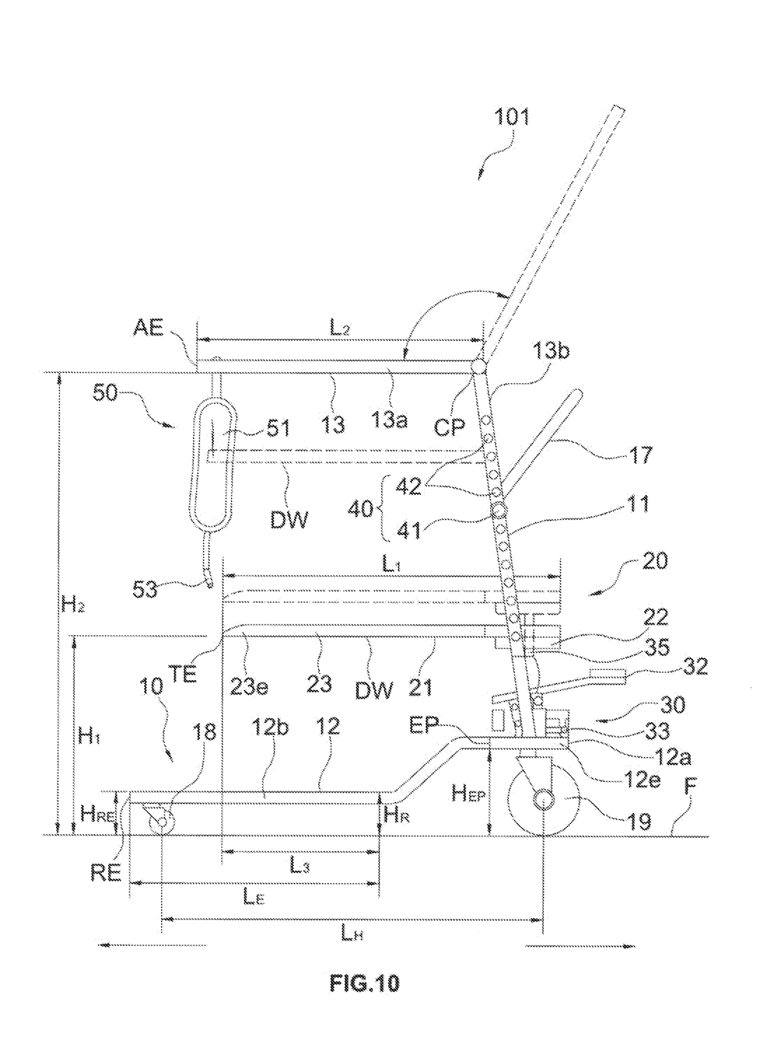

Referring to FIG. 10, there is disclosed a second embodiment of the nursing care support device 101 according to the present invention. Each member or the nursing care support device 101 is compatible with each member and the same reference numerals shown in nursing care support 100 shown in the first embodiment, having a shape identical to each member of the nursing care support 100. In the following description, describes only the portion having a shape different from the first embodiment.

In the second embodiment of the device 101, the two rods of the arm part 13a are hingedly connected to the two rods of the project part 13b and the horizontal rod of the connection part 13c so that the two rods can be pivoted around the projection part 13b and connection part 13c. As shown in FIG. 10, the arm part 13a may be raised up from the horizontal position (which is indicated in the solid line) to a lift up position with the rear end pointing up as a slightly tilted vertical position (which is indicated in the dashed line).

The nursing care support 101 miniaturization has been promoted to account for general use in the home, such as the corridor is limited. More specifically, a smaller rise-and-fall unit 30 is used than in a Nursing care support device 100, thus the area of the pedestal portion 12a has been reduced due to the smaller size of the rise-and-fall unit 30. As shown in FIG. 10, the final operation unit 17 is also miniaturized with the device 101.

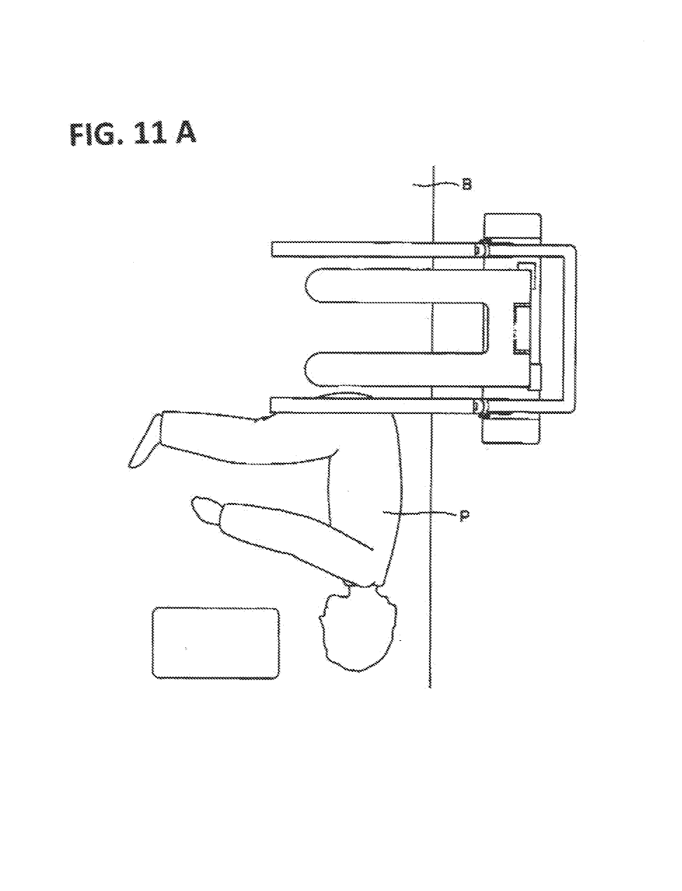

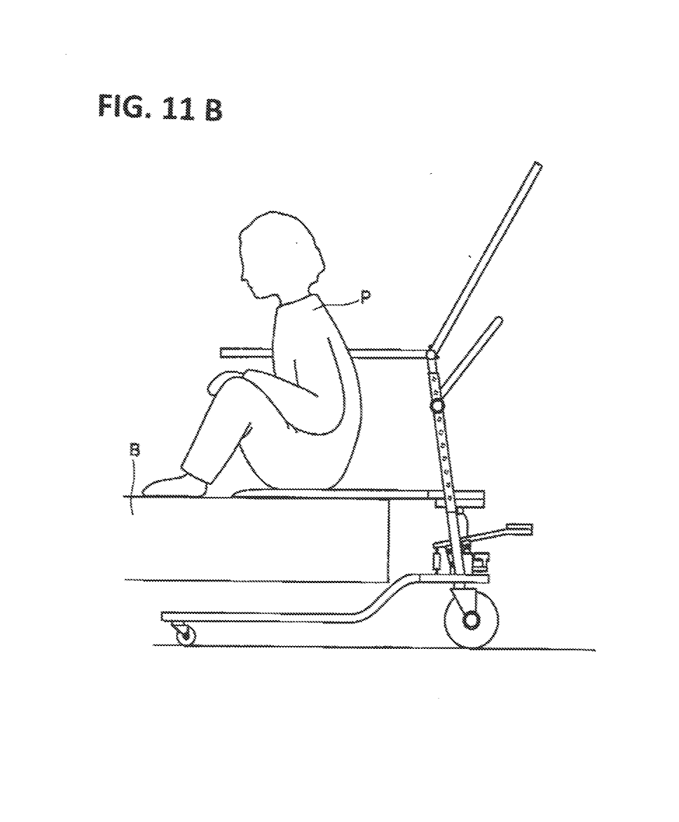

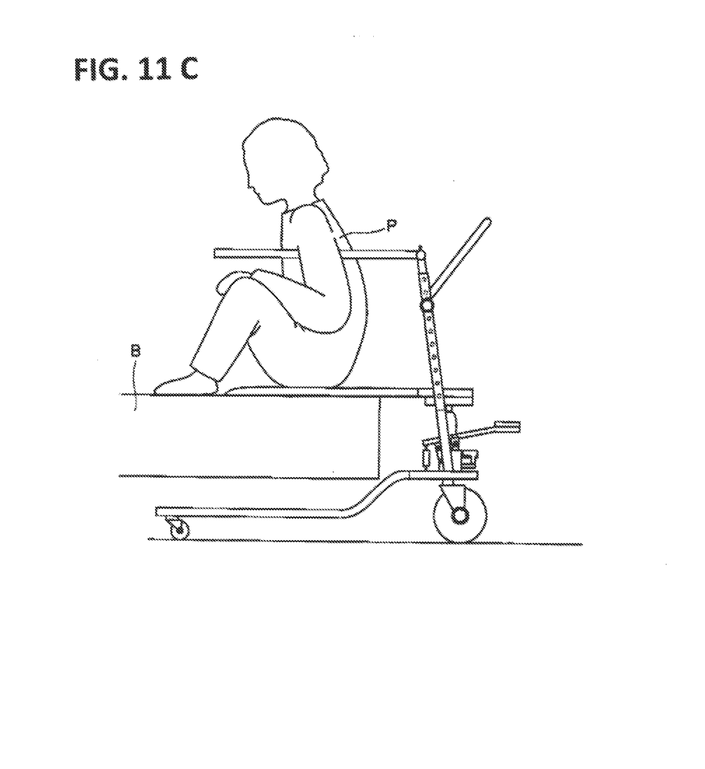

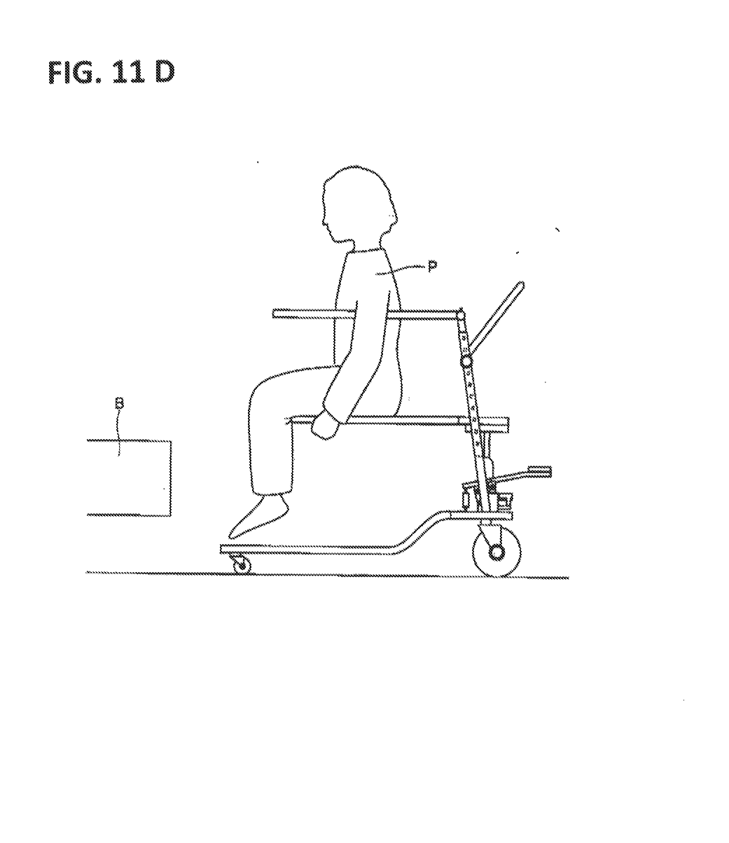

Hereinafter, FIGS. 11A-11D illustrate how to use the nursing care support device 101 to move a person who needs nursing care 101.

First, the person P who needs care lying on the bed B in a posture that her back faces and near the bed side. Move the nursing care support device close the bed B with the plate 23 of plug component 21 near the buttocks of the person P (FIG. 11A). Subsequently, raise up one of the rod of the arm part 13a. Help or ask the person P to sit up, once the person sits up, she will sit on the plate 23 (FIG. 11B). Put down the rod of the arm part 13a back to horizontal position. The person then put her arms over and around the arm part to stabilize her posture. Both rods of the arm part 13a secure the person P and thus prevent the person P from falling on the sides (FIG. 11C). Later, as described earlier, raise the seat 20 (including plate 23 of the plug component 21) using the rise-and-fall device 30. Then, slowly pull the device 101 away from the bed B in this state, the person P requiring care can be moved from the bed (FIG. 11D).

The move method explained with reference to FIG. 11A-D is suitable for movement of the person P requiting care who cannot maintain a seating posture by herself. The person P requiring care can also be moved by the method explained with reference to FIG. 8 A-D using the second embodiment of the nursing care support device 101. First embodiment of the nursing care support 100 can also be used to move the person P requiring care according to the method explained with reference to FIG. 11A-D. The nursing care support device second embodiment 101 also fits the use as walk supplementary device as shown in FIG. 9.

The nursing care support device including first and second embodiment 100, 101 according to the present invention can be used to lift and transfer a person who cannot move around on their own. Moreover, it can also be used as device for assisting walk. The nursing care support device 100, 101 according to the present invention is valuable in ordinary homes, a hospice, a hospital, a welfare institution for the aged, etc.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A nursing care support device comprising:
a wheeled truck part comprising:
two parallel elongated frame members having a top and bottom, a pedestal part connected to the two frame members having a rectangular shape having a top and bottom, two small wheels attached to the bottom of the two frame members, and two large wheels attached to the bottom of the pedestal part;
a post frame comprising two parallel pipes which extend upwards from the top of the pedestal part;
an upper body support frame comprising
a projection part including two parallel upward rods which fitted into the post pipes from their top ends and fastened by screws,
a connection part including a horizontal rod perpendicularly connected to the two upward rods,
and an arm part including two parallel horizontal rods perpendicularly connected to the connection part's horizontal rod and the projection part's upwards rods;
an operation unit connected to the post comprising a hand gripping portion for a caregiver to push the device;
a rise-and-fall unit located on the pedestal part comprising a hoist machine, pressure pedals, and mobilized robot; and
a seating part comprising a supporting component which is connected to top of the mobilized robot and is moved up and down by the mobilized robot, and a plugging component which is hingedly connected to one edge of the supporting component and pivots about the edge of the supporting component such that the plug component can be placed in a horizontal position or a raised position;
wherein the plug component has two parallel elongated plates which are separate by a predetermined distance I and connected by a connecting plate near their front ends, the plates have a tapered shape near the rear end (TE), each of the plates has a full length L1 which is from the front end to the rear end and a length L4 which starts from the point jointing the connecting plate to the rear end, a width W and a thickness T, both the width W and thickness T gradually decrease within the section E which is near the rear end towards the rear end tip (TE) to facilitate easy plugging in between the person requiring nursing care and the furniture.

2. The nursing care support device of claim 1 further comprising a rear support to secure the back side of the person sitting on the device 100 which includes a supporter cloth which is removably attached to the rear end of one rod of the arm part, a pin which is attached to the supporter cloth, and a hole which is located on the end of the other rod of the arm part, wherein the support cloth can be disposed across the two ends of the rods of the arm part to secure the backside of the person who sits on the device by inserting the pin into the hole.

3. The nursing care support device of claim 1, wherein the width W of the plates excluding the section E is 5 cm to 15 cm, and preferably 6 cm to 13 cm, and most preferably 7 cm to 12 cm.

4. The nursing care support device of claim 1, wherein the thickness T of the plates excluding the section E is 1 cm to 4 cm, and preferably 1 cm to 3 cm.

5. The nursing care support device of claim 3, wherein the distance I between the two plates excluding the section E is 5 cm to 25 cm, and preferably 9 cm to 23 cm, and most preferably 12 cm to 18 cm.

6. The nursing care support device of claim 1, wherein the full length L1 of the plates is 45 cm to 75 cm, and preferably 50 cm to 65 cm.

7. The nursing care support device of claim 1, wherein the length L4 of the plates is 40 cm to 65 cm and preferably 45 cm to 60 cm.

8. The nursing care support device of claim 1, wherein the distance H_{EP} between the bottom of the pedestal part and the floor surface is 15 cm to 30 cm, and preferably 17 cm to 27 cm, and most preferably 20 cm to 25 cm.

9. The nursing care support device of claim 1, wherein each of the elongated frame members has a horizontal region, the distance H_{RE} from the upper surface of the horizontal region of each elongated frame member to the floor is 5 cm to 12 cm and preferably 5 cm to 10 cm and most preferably 5 cm to 8 CM.

10. The nursing care support device of claim 1, wherein the height of the arm part (H2) which is the distance from the underneath of the arm part's horizontal rod to the floor surface can be adjusted by adjusting the lengths of the upward rods of the upper body support frame beyond the top ends of the post pipes, the height of the arm part is 110-140 cm and preferably 120 cm for the device to be used as a walking aid and 65-75 cm for the device to be used as a carrying device.

11. The nursing care support device of claim 10, wherein the height of the arm part (H2) can be adjusted by adjusting the lengths of the upward rods of the upper body support frame beyond the top ends of the post pipes.

12. The nursing care support device of claim 1, wherein the hoist machine is a hydraulic jack.

13. The nursing care support device of claim 1, wherein the device is used as a carrying device to help lift a person who requires nursing care when the plug component is pushed down in a horizontal position or the device is used as a walking aid when the rear end of the plug component is lifted and pointing upwards.

14. The nursing care support device of claim 13, wherein the seating part is lower down before the plug component is inserted between the person requiring nursing care and the sitting furniture and is raised up after the plug component is securely placed beneath the person so that the person can be lift up from the furniture and move to another location, the up and down movement of the seating part is enabled by the rise-and-fall unit.

15. The nursing care support device of claim 14, wherein the seating part can be moved up to a highest position and moved down to a lowest position, the difference between the highest position and the lowest position is 10 cm-30 cm and preferably 15 cm-30 cm.

16. The nursing care support device of claim 1, wherein the ends of the two rods of the arm part are hingedly connected to the ends of the rod of the connection part and the rods of the projection part so that the rods of the arm part can pivot about the rod of the connection part and the rods of the projection part and can stay in an horizontal position or a slightly tilted upright position.

17. The nursing care support device of claim 1, wherein the post's pipes tilted from the vertical direction by 5-30 degrees, and preferably 7 to 20 degrees.

18. The nursing care support device of claim 1, the thickness T around the region near the rear end is 1 cm to 10 cm and preferably 2 cm to 8 cm.
